(19) United States
(12) Patent Application Publication
(10) Pub. No.: US 2010/0157964 A1
(43) Pub. Date: Jun. 24, 2010

(54) SERVER TO GUIDE RECONNECTION IN MOBILE INTERNET, METHOD FOR GUIDING SERVER RECONNECTION, AND SERVER RECONNECTION METHOD

(75) Inventor: Hyoung Sik YOON, Seoul (KR)

Correspondence Address: H.C. PARK & ASSOCIATES, PLC, 8500 LEESBURG PIKE, SUITE 7500, VIENNA, VA, 22182, US

(73) Assignee: PANTECH & CURITEL COMMUNICATIONS, INC., Seoul (KR)

(21) Appl. No.: 12/638,087

(22) Filed: Dec. 15, 2009

(30) Foreign Application Priority Data
Dec. 18, 2008 (KR) 10-2008-0129151
Aug. 17, 2009 (KR) 10-2009-0075701

(51) Int. Cl. H04W 76/00

(52) U.S. Cl. 370/338

(57) ABSTRACT

If a terminal attempts a connection to an Internet site while a server in charge of the site is under maintenance, a connection request may be denied and an error message is sent to the terminal. After the server maintenance returns to a connection enabled state, a connection guide message is sent to notify the terminal. The server includes a communication unit, a message generator, a storage unit to store identification information of the terminal, and a controller. The server generates the error message if the connection attempt occurs while the server is in a connection disabled state, generates the connection guide message if the connection disabled state is released, and transmits the messages to the terminal. The server performing the connection management function may be a content server or a connection management server.

### CROSS-REFERENCE TO RELATED APPLICATIONS

This application claims priority from and the benefit of Korean Patent Application No. 10-2008-0129151, filed on Dec. 18, 2008, and Korean Patent Application No. 10-2009-0075701, filed on Aug. 17, 2009, which are both hereby incorporated by reference for all purposes as if fully set forth herein.

### BACKGROUND OF THE INVENTION

1. Field of the Invention

Embodiments of the present invention relate to providing Internet services to a mobile terminal that performs communication via a mobile Internet, and more particularly, to a system and a method for guiding server reconnection in the mobile Internet and a method for server reconnection of a terminal.

2. Discussion of the Background

As the number of the mobile terminal users increases, the mobile Internet is more widely used. However, connection to Internet sites may be temporarily disabled, for example, due to the maintenance of the server in charge of a particular site.

If a conventional terminal attempts a connection to a site under maintenance, the connection is performed as illustrated in FIG. 1. First, the terminal attempts a connection to the server in charge of a particular site while the server is in a connection disabled. Then, the server transmits an error message for notifying the connection disabled state to the terminal. Then, the terminal receives the error message transmitted from the server, displays the error on a screen of the terminal, and displays a message asking the user whether to re-attempt a connection to the server.

The terminal user may recognize that the error occurs and may attempt another connection to the server in charge of the site. Here, if the server is still in a connection disabled state, the server transmits another error message for notifying the connection disabled state to the terminal. The terminal receives the error message transmitted from the server, displays the error on the screen, and displays the message asking the user whether to re-attempt a connection to the server.

As described above, if a terminal attempts a connection to an Internet site which is under maintenance, only the error message which requests to reconnect later is displayed on the screen. Accordingly, the terminal user who attempts the connection to the site cannot know when the connection to the site is available. In addition, after subsequent failed attempts to connect to the site while the site is still in the connection disabled state, the terminal user may give up the connection to the site.

### SUMMARY OF THE INVENTION

Exemplary embodiments of the present invention provide a system to guide server reconnection in mobile Internet, a method for guiding server reconnection in the mobile Internet, and a method for server reconnection of a terminal. According to the exemplary embodiments, when a site returns to a connection enabled state, the terminal may receive a message to be guided to attempt a connection to the site.

Additional features of the invention will be set forth in the description which follows, and in part will be apparent from the description, or may be learned by practice of the invention.

An exemplary embodiment of the present invention discloses a server, including: a communication unit to communicate with a terminal via a communication network; a message generator to generate an error message if a connection attempt of the terminal occurs while the server is in a connection disabled state, and to generate a connection guide message if the connection disabled state is released; a storage unit to store identification information of the terminal; and a controller to control the storage unit to store the identification information of the terminal if the connection attempt of the terminal occurs while the server is in the connection disabled state, to control the message generator to generate the error message and transmit the error message to the terminal via the communication unit, and to control the message generator to generate the connection guide message with the terminal designated as a receiver and transmit the connection guide message to the terminal via the communication unit.

An exemplary embodiment of the present invention discloses a method for guiding server reconnection, including: if a connection attempt of a terminal to a server occurs while the server is in a connection disabled state, storing identification information of the terminal, generating an error message, and transmitting the error message to the terminal; and if the connection disabled state of the server is released, generating a connection guide message with the terminal designated as a receiver, and transmitting the connection guide message to the terminal.

An exemplary embodiment of the present invention discloses a method for server reconnection of a terminal, including: attempting a first connection to a server, and receiving and displaying an error message informing that the server is in a connection disabled state; receiving and displaying a connection guide message informing that the server's connection disabled state is released, and attempting a second connection to an access address included in the connection guide message to connect to the server by the terminal.

An exemplary embodiment of the present invention discloses a method for guiding reconnection to a server, including: if a terminal attempts a first connection to a content server while the content server is in a connection disabled state, registering connection failure information comprising identification information of the content server and identification information of the terminal by a connection management server; generating a first error message and transmitting it to the terminal; and generating a connection guide message if the connection disabled state of the content server is released, and transmitting it to the terminal.

An exemplary embodiment of the present invention discloses a method for guiding reconnection to a server, including: if a terminal attempts a first connection to a content server while the content server is in a connection disabled state, registering connection failure information comprising identification information of the content server and the terminal by a connection management server; generating a first error message, the first error message comprising an inquiry whether to receive a connection guide message after the connection disabled state of the content server is released, and transmitting the first error message to the terminal; and generating a connection guide message if the connection disabled state of the content server is released after a response to the first error message is received from the terminal, and transmitting the connection guide message to the terminal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates a process of denying site access due to server maintenance in conventional mobile Internet.

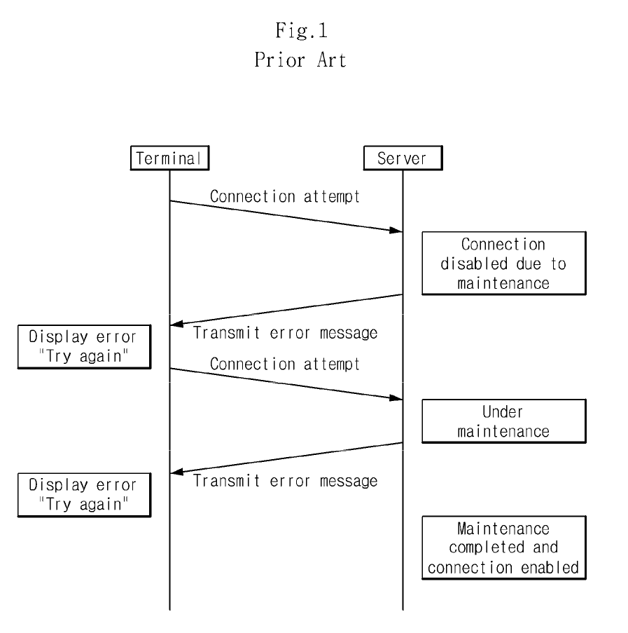

FIG. 2 is a view illustrating a system to guide server reconnection in mobile Internet according to an exemplary embodiment of the present invention.

FIG. 3 is a view illustrating a server according to an exemplary embodiment of the present invention.

FIG. 4 is a view illustrating a terminal according to an exemplary embodiment of the present invention.

FIG. 5 illustrates a method for guiding server reconnection in mobile Internet according to an exemplary embodiment of the present invention.

FIG. 6 illustrates a method for guiding server reconnection in mobile Internet according to an exemplary embodiment of the present invention.

FIG. 7 illustrates a method for guiding server reconnection in mobile Internet according to an exemplary embodiment of the present invention.

FIG. 8 illustrates a method for guiding server reconnection in mobile Internet according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

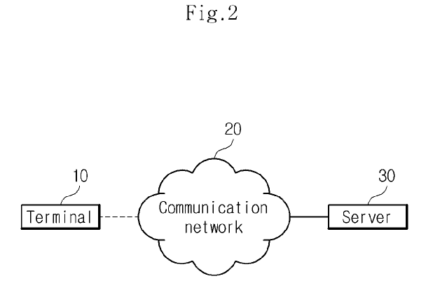

FIG. 2 is a view illustrating a system to guide server reconnection in mobile Internet according to an exemplary embodiment of the present invention. A system to guide server reconnection in mobile Internet according to an exemplary embodiment includes, as illustrated in FIG. 2, a terminal 10, a communication network 20, and a server 30. The terminal 10 may be a mobile terminal, and performs wireless communication to connect to an Internet site through the communication network 20, downloads page information from the site in the connected state, and then displays it on a screen to allow a user to use the site.

The server 30 is in charge of the site to which the terminal 10 connects. The server 30 receives a communication connection request from the terminal 10 and transmits the page information on the site to the terminal 10 to allow the terminal 10 to use the site.

In addition, if a connection attempt of the terminal 10 occurs while the server 30 is under maintenance, the server 30 stores identification information of the terminal 10 which attempts the connection and transmits to the terminal 10 an error message for notifying the terminal 10 that the server 30 is in a connection disabled state due to the maintenance. The terminal 10 receives the error message, for example, “Currently unable to connect. Notification will be made when connection is possible.”, and displays it on the screen.

If the server 30 returns to a connection enabled state, the server 30 transmits a connection guide message on the basis of the identification information of the terminal 10, which was stored when the connection attempt of the terminal 10 occurred. That is, the server 30 transmits to the terminal 10 the connection guide message for guiding a connection to the site that the server 30 is in charge of to allow the screen of the terminal 10 to display the connection guide message for guiding the communication connection. As described above, if a connection attempt of the terminal 10 occurs after the server 30 transmits the connection guide message to the terminal 10, the server 10 transmits the page information on the site that the server 10 is in charge of to the terminal 10 to allow the terminal 10 to use the site.

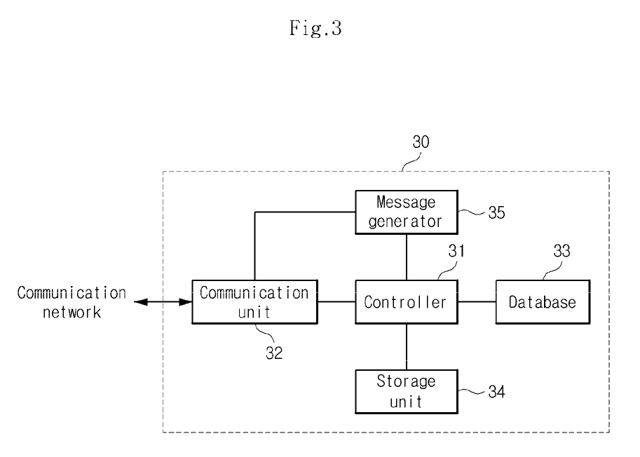

FIG. 3 is a view illustrating a server according to an exemplary embodiment of the present invention. The server 30 having the above-mentioned function may include, as illustrated in FIG. 3, a controller 31, a communication unit 32, a database 33, a storage unit 34, and a message generator 35. The communication unit 32 is connected to the communication network 20 and communicates with the terminal 10 via the communication network 20. The communication unit 32 receives the communication connection attempt from the terminal 10, transmits it to controller 31, transmits the page information output from the controller 31 to the terminal 10 via the communication network 20, and transmits the error message and the connection guide message output from the message generator 35 to the terminal 10 via the communication network 20.

The database 33 stores the page information on the site that the server 30 is in charge of and outputs the page information according to the control of the controller 31. If the terminal 10 attempts a communication connection while the server 30 is under maintenance, the storage unit 34 stores the identification information of the terminal 10 input from the controller 31 and outputs the identification information of the terminal 10 according to the control of the controller 31.

The message generator 35 generates the error message and the connection guide message according to the control of the controller 31 and outputs them to the communication unit 32. Specifically, the message generator 35 receives the identification information of the terminal 10 input through the controller 31, generates the error message and the connection guide message with the terminal 10 designated as a receiver, and outputs them to the communication unit 32 so as to allow the communication unit 32 to transmit the error message and the connection guide message to the terminal 10. For example, if the error message is to be generated according to the control of the controller 31, the message generator 35 generates a text message notifying the terminal 10 that the server 30 is “Currently unable to connect. Notification will be made when connection is possible.”. If the connection guide message is to be generated according to the control of the controller 31, the message generator 35 generates a text message for notifying the terminal 10 that “Connection to xxx is enabled. Press OK if you want to connect”. Such a text message may include the page address of the corresponding site to connect to the site, and the terminal 10 may attempt the connection to the site using the page address if the user presses OK.

The error message and the connection guide message which are generated by the message generator 35 may be transmitted in the form of a WAP Push Message through the communication network 20. Since the connection guide message generated and transmitted by the message generator 35 may include the page address for connection to the site, if the user of the terminal 10 receives the connection guide message presses OK after checking the connection guide message, the terminal 10 attempts to connect via the page address.

The controller 31 controls the operations of the server 30. If the communication connecting attempt of the terminal 10 occurs via the communication unit 32 while the server 30 is not under maintenance but is in a normal operable state, the communication unit 32 extracts the site page information stored in the database 33 and transmits it to the terminal 10 via the communication unit 32. Consequently, the terminal 10 can access the desired site via the server 30.

If the communication connecting attempt of the terminal 10 occurs via the communication unit 32 while the server 30 is under maintenance, the controller 31 stores the identification information of the terminal 10 attempting the connection in the storage unit 34. The identification information is transmitted to the message generator 35 to allow the message generator 35 to generate the error message with the terminal 10 as the recipient so as to transmit the error message to the terminal 10 via the communication unit 32.

When the maintenance is completed and the server 30 is in a connection enabled state, the controller 31 transmits the identification information of the terminal 10 extracted from the storage unit 34 to the message generator 35. The message generator 35 then generates the connection guide message to be transmitted to the terminal 10 and transmits it to the terminal 10 via the communication unit 32. The terminal 10 that receives the connection guide message displays the message on the screen to guide the terminal user to connect to the site when the maintenance of the server 30 is completed.

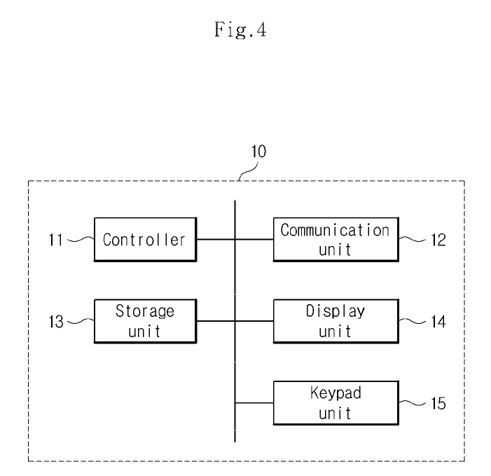

FIG. 4 is a view illustrating a terminal according to an exemplary embodiment of the present invention. The terminal 10 includes, as illustrated in FIG. 4, a controller 11, a communication unit 12, a storage unit 13, a display unit 14, and a keypad unit 15. The communication unit 12 performs wireless communication via the communication network 20 according to the control of the controller 11 to communicate with an Internet site. The communication unit 12 attempts a connection to the server 30 in charge of the Internet site, receives the error message and the connection guide message transmitted from the server 30, and transmits them to the controller 11. The storage unit 13 stores programs and data used for communication control performed by the control unit 11.

The display unit 14 displays on the screen an image input and output when the Internet site is connected and used according to the control of the controller 11 in order to allow visual checking of the Internet site. The keypad unit 15 is provided with a manual operating key to input a command to the terminal 10, and inputs the command by a manual operation of the user to the controller 11.

The controller 11 controls the operation of the terminal 10 on the basis of the program and the data stored in the storage unit 13.

The controller 11 attempts a communication connection to the server 30 in charge of the site via the communication unit 12. If the controller 11 receives the error message transmitted from the server 30, the controller 11 displays the error message, for example, “Currently unable to connect. Notification will be made when connection is possible.” on the display unit 14 to allow the user to suspend the connection until the connection is enabled.

In addition, if the controller 11 receives the connection guide message transmitted from the server 30 via the communication unit 12, for example, “Connection to xxx is enabled. Press OK if you want to connect.”, the controller 11 displays it on the display unit 14 to guide the user to attempt a connection to the site. If the connection guide message includes the page address of the site, the user may attempt the connection to the page address via the communication unit 12 by pressing a button of the keypad unit 15, such as an OK button.

If the terminal 10 attempts the connection to the server 30 in charge of a particular site for connection to the site, and the server 30 is under maintenance, the server 30 stores the identification information of the terminal 10 in the storage unit 34, and the message generator 35 generates the error message. The server 30 generates the error message, for example, “Currently unable to connect. Notification will be made when connection is possible.”, and transmits it to the terminal 10 in the form of a WAP Push Message. The server 30 transmits the error message to output the error message on the screen of the terminal 10 and guides the terminal user to suspend the connection to the site until the maintenance is completed.

When the maintenance of the server is completed, the server 30 allows the message generator 35 to generate the connection guide message for the identification information of the terminal 10 designated as a receiver, for example, “Connection to xxx is enabled. Press OK if you want to connect”. Thereafter, the server 30 transmits the generated message in the form of a WAP Push Message to the terminal 10 via the communication network 20. The terminal 10 may display the connection guide message on the screen of the terminal 10 to guide the terminal user to connect to the site. Here, the connection guide message transmitted to the terminal 10 from the server 30 may include the page address of the site, and in this case, the terminal user may connect to the site via the page address by pressing OK.

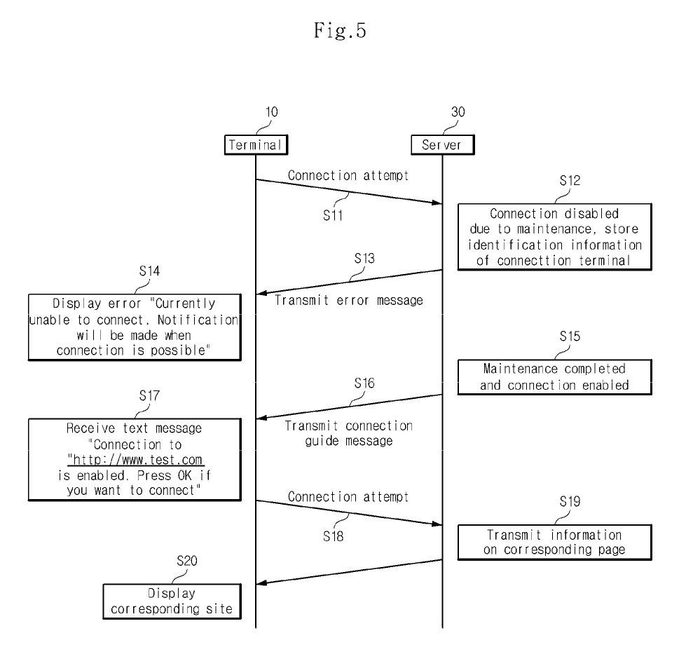

FIG. 5 illustrates a method for guiding server reconnection in mobile Internet according to an exemplary embodiment of the present invention. The system to guide server reconnection in mobile Internet according to the above-described exemplary embodiment may perform operations illustrated in FIG. 5. However, the method is not limited thereto, but will be described as such for clarity.

The terminal 10 attempts the connection to the server 30 in charge of a site for connection to the site (S11). Here, if the server 30 is in a connection disabled state for maintenance, the controller 31 of the server 30 stores in the storage unit 34 the identification information of the terminal 10 attempting the connection (S12). Then, the controller 31 allows the message generator 35 to generate the error message, for example, “Currently unable to connect. Notification will be made when connection is possible.”, and the error message is transmitted it to the terminal 10 in the form of a WAP Push Message (S13).

The controller 11 of the terminal 10 receives the error message via the communication unit 12 and displays it on the screen of the display unit 14. For example, the terminal 10 outputs the error message “Currently unable to connect. Notification will be made when connection is possible.” and guides the terminal user to attempt a connection later (S14).

Then, the controller 31 of the server 30 checks whether the maintenance of the server is completed and the server is in a connection enabled state (S15). If so, the server 30 extracts the identification information of the terminal 10 stored in the storage unit 34 and provides it to the message generator 35 to allow the message generator 35 to generate the connection guide message. Here, the server 30 may generate the connection guide message including the site page address, for example, “Connection to http://www.test.com is enabled. Press OK if you want to connect.”, and the connection guide message is transmitted to the terminal 10 in the form of a WAP Push Message (S16).

The controller 11 of the terminal 10 receives the connection guide message via the communication unit 12 and displays it on the screen of the display unit 14. For example, the controller 11 of the terminal 10 outputs the connection guide message “Connection to http://www.test.com is enabled. Press OK if you want to connect.”, and guides the terminal user to attempt the connection to the site (S17).

Here, if the user presses the OK button provided in the keypad unit 15 of the terminal 10 to attempt the connection to the site (S18), the controller 31 of the server 30 in charge of the site extracts the page information on the site from the database 33 and the page information is transmitted it to the terminal 10 via the communication unit 32 (S19). The terminal 10 receives the page information and displays it on the screen of the display unit 14 to allow the terminal user to use the site (S20).

In the above description, the server 30 transmits the error message and the connection guide message to the terminal 10 in the form of a WAP Push Message. However, the server 30 may guide reconnection using a different type of message format. For example, the error message and the connection guide message may be a packet paging type.

A method for guiding reconnection in the packet paging type will now be described. If the terminal 10 attempts a connection to the server 30, and connection failure occurs due to the maintenance of the server 30, the server 30 cannot transmit page information on a site to the terminal 10. Upon receiving an error message, the terminal 10 may enter a dormant state. In the case of the connection failure, when the maintenance of the server 30 is completed, the server 30 transmits a message for guiding the connection to the site through packet paging via the communication network 20. The terminal 10 displays the connection guide message received from the server 30 on the screen to guide the terminal user to connect to the site. The message transmitted through the packet paging for guiding the connection to the site may include the page address for connection to the site.

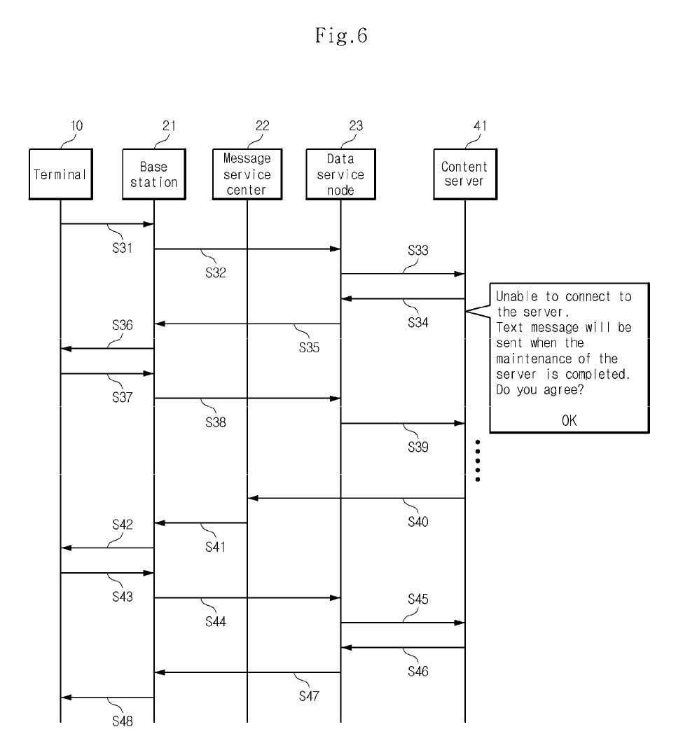

FIG. 6 illustrates a method for guiding server reconnection in mobile Internet according to an exemplary embodiment of the present invention. In the exemplary embodiment shown in FIG. 6, a content server 41 stores identification information of the terminal 10 that attempts the connection, and the content server 41 transmits a connection guide message to the terminal 10 when the content server 41 returns to a connection enabled state.

A base station 21, a message service center 22, and a data service node 23 are positioned in the communication network 20 to connect the terminal 10 to the content server 41 to allow the terminal user to use the mobile Internet. The content server 41 is a server that provides the reconnection guide function. The content server 41 is also in charge of the site to which the user wants to connect to provide contents of the site to the terminal 10 via the communication network 20.

If the terminal 10 attempts the connection to the content server 41 via the base station 21 (S31), the base station 21 requests a Point-to-Point Protocol (PPP) connection to the data service node 23 (S32). The data service node 23, which receives the PPP connection request, requests a socket connection to the content server 41 (S33).

If the content server 41 is under maintenance or is in a connection disabled state for another reason, the content server 41 transmits the error message in response to the socket connection request of the data service node 23 (S34). For example, the data service node 23 is a Packet Data Serving Node (PDSN). Moreover, the content server 41 stores the identification information of the terminal 10 that fails to connect in order to guide the reconnection later.

The error message is a message for guiding the terminal user to suspend the connection to the content server 41, and may further include a content that asks the terminal user whether or not to receive the connection guide message after the restoration of the content server 41 is completed. For example, the content server 41 may request the generation of the error message “Unable to connect to the server. A text message will be sent when the maintenance of the server is completed. Do you agree?”.

If the content server 41 requests the data service node 23 to generate the error message, the data service node 23 transmits the error message to the terminal 10 via the base station 21. The terminal 10 notifies the connection failure on the screen, and displays the message that asks whether or not to receive the connection guide message later (S35 and S36).

If the terminal user selects to receive the connection guide message later, such as by pressing the button of the terminal 10 or the like, the terminal 10 transmits the selection result to the base station 21 and the data service node 23 (S37 and S38). The data service node 23 informs the content server 41 that the terminal 10 has selected to receive the connection guide message later (S39).

If the maintenance of the content server 41 is completed and the content server 41 is in a connection enabled state, the content server 41 extracts the identification information of the terminal 10 which has selected to receive the connection guide message and generates the connection guide message with the terminal user designated as a receiver. The connection guide message generated here is transmitted to the terminal 10 via the message service center 22 and the base station 21 (S40, S41, and S42). For example, the message service center 22 may be a Short Message Service Center (SMSC), and the connection guide message may be an SMS message. The connection guide message informs that the content server 41 is in the connection enabled state and may be in the form of a WAP Push Message that asks the terminal user whether to reconnect to the content server 41.

If the terminal user checks the content of the connection guide message on the terminal 10 and attempts the reconnection to the content server 41 (S43), the base station 21 requests the PPP connection to the data service node 23 (S44). The data service node 23 that receives the PPP connection request requests the socket connection again to the content server 41 (S45). The content server 41 transmits a response to the request of the data service node 23 in the connection enabled state and completes the connection (S46). Then, the content server 41 extracts the page information on the site that the terminal user requests and transmits it to the terminal 10 via the data service node 23 and the base station 21 (S46, S47, and S48). The terminal 10 receives the page information and displays it on the screen to allow the terminal user to use the site.

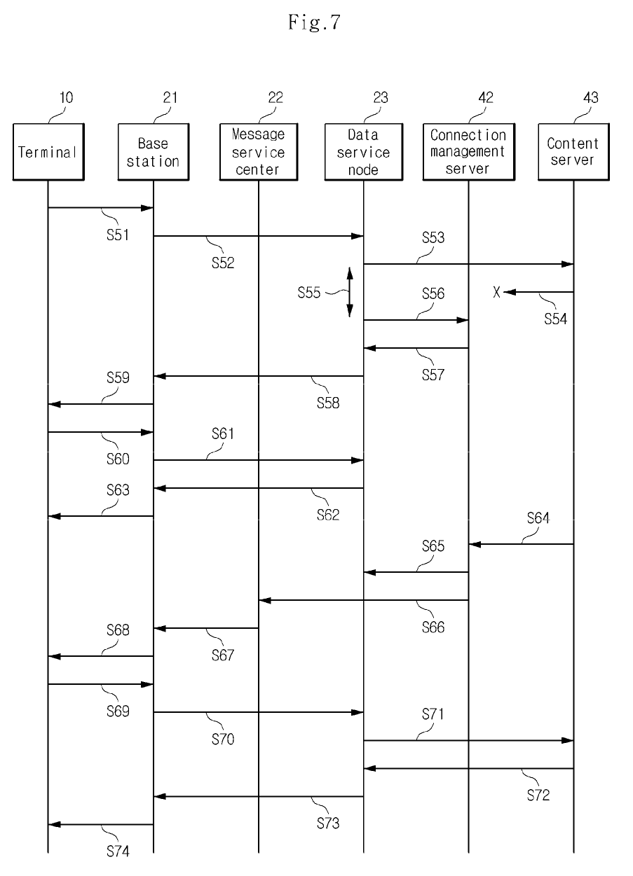

FIG. 7 illustrates a method for guiding server reconnection in mobile Internet according to an exemplary embodiment of the present invention.

In the exemplary embodiment shown in FIG. 7, the connection management is performed on all connections regardless of the intention of the terminal user. In this embodiment, the connection management server 42 is a server that provides the reconnection guide function, and unlike in FIG. 6, the content server 43 of FIG. 7 implements only the content providing function, not the reconnection guide function.

The terminal 10 attempts a connection to the content server 43 that provides the page information on the site that the user wants according to an input of the user (S51). Then, the base station 21 requests a PPP connection to the data service node 23 that manages the content server 43 (S52), and the data service node 23 requests a socket connection to the content server 43 (S53).

If the content server 43 is under maintenance or is in a connection disabled state for any other reason, it cannot respond to the connection attempt (S54). In the case there is no response from the content server 43 for a predetermined time (S55), the data service node 23 recognizes that the content server 43 is in the connection disabled state, and registers connection failure information including the identification information of the content server 43 and the terminal 10 in the connection management server 42 for the reconnection process to be performed later (S56).

When the registration of the connection failure information is completed in the connection management server 42 (S57), the data service node 23 generates the error message for informing the connection failure and guiding to suspend the connection, and transmits it to the terminal 10 via the base station 21 (S58 and S59).

Through the aforementioned process, the site that the content server 43 is in charge of is registered in the connection management server 42 as the connection disabled state, and the data service node 23 recognizes that the site is in the connection disabled state by communicating with the connection management server 42.

Accordingly, if the terminal 10 attempts a second connection attempt while the connection disabled state of the content server 43 is not released, the data service node 23 may transmit the error message informing that the content server 43 is in the connection disabled state without first checking the connection state of the content server 43.

Specifically, if the terminal 10 attempts again the connection to the content server 43 (S60) and the base station 21 requests the PPP connection to the data service node 23 (S61), the data service node 23 recognizes that the content server 43 is still in the connection disabled state, generates the error message without contacting the connection management server 42, and transmits it to the terminal 10 via the base station 21 (S62 and S63). In FIG. 7, it is shown that the data service node 23 performs the function of transmitting the error message according to the reconnection attempt in the state where the connection disabled state of the content server 43 is not released. However, this function may be implemented by the connection management server 42.

When the content server 43 is restored and is in a connection enabled state, the content server 43 informs the connection management server 42 and the data service node 23 of this, and releases its connection disabled state (S64 and S65). In order to transmit to the terminal 10 the connection guide message for guiding to connect to the content server 43, the connection management server 42 registers the message in the message service center 22 (S66).

Then, the message service center 22 transmits the connection guide message in the form of a WAP Push Message or a packet paging type to the terminal 10 via the base station 21 (S67 and S68).

If the terminal user checks the connection guide message on the screen of the terminal 10 and attempts to reconnect by a method such as pressing a button (S69), the base station 21 requests the PPP connection from the data service node 23 (S70).

When the socket connection from the data service node 23 to the content server 43 is requested (S71), the content server 43 that is in the normal operational state extracts the page information on the site that the terminal user has requested, and transmits the extracted content along with a response to the connection request to the data service node 23 (S72). The page information is transmitted to the terminal 10 via the base station 21 (S73 and S74).

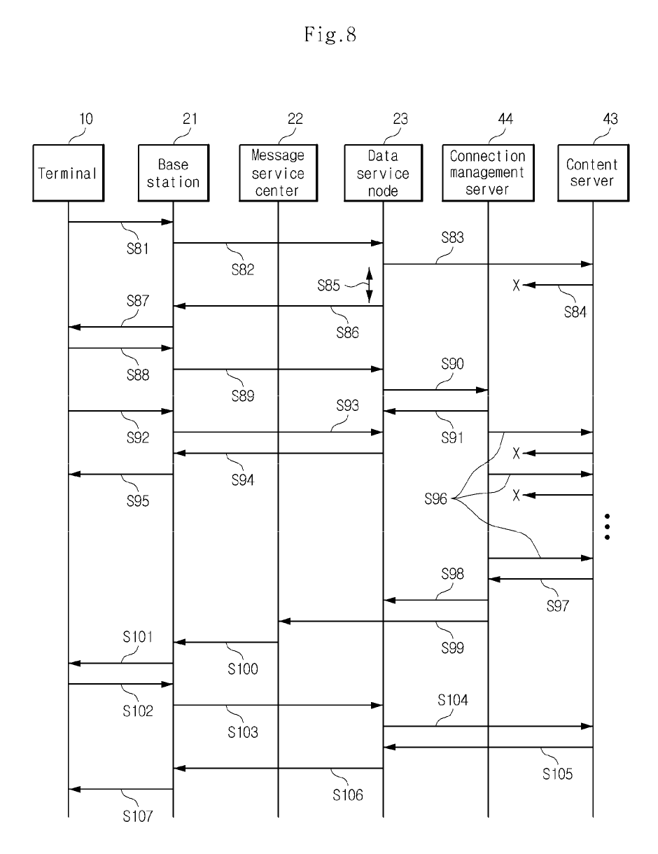

FIG. 8 illustrates a method for guiding server reconnection in mobile Internet according to an exemplary embodiment of the present invention. In this embodiment, the connection management server 44 is a server that provides the reconnection guide function, and the content server 43 has the same function as that in FIG. 7.

In the embodiment of FIG. 8, connection management is performed in response to a request from the user of the terminal 10. Specifically, if the connection fails, after checking the intention of the user of the terminal 10 about whether or not the user selects to receive the connection guide message later, the related information is registered in the connection management server 44, and the connection guide message is transmitted to the user when the content server 43 is restored only if the user so requests.

A connection attempt of the terminal 10 to the content server 43 occurs through the connection attempt (S81) of the terminal 10, the PPP connection request (S82) of the base station 21, and the socket connection request (S83) of the data service node 23.

When the content server 43 is in the connection disabled state due to maintenance or the like, the data service node 23 does not receive a response to the connection request from the content server 43 (S84). The data service node 23 waits for the response from the content server 43, and after a predetermined time, determines that the content server 43 is in the connection disabled state (S85).

Then, the data service node 23 generates the error message for informing the connection disabled state of the content server 43 and guiding to suspend the connection, and transmits it to the base station 21 and to the terminal 10 (S86 and S87). The error message may include the content that asks whether or not to receive the connection guide message when the connection disabled state is released after the restoration of the content server 43 is completed.

If the terminal user selects to receive the connection guide message later and informs the data service node 23 of this intention via the base station 21 (S88 and S89), the data service node 23 registers the connection failure information in the connection management server 44 (S90). For the reconnection, the connection failure information may include the identification information of the content server 43 and the terminal 10.

After completing the registration of the connection failure information, the connection management server 44 informs the data service node 23 of this (S91).

If a connection attempt of the terminal 10 occurs again (S92), the base station 21 requests a PPP connection to the data service node 23 (S93). However, since the connection disabled state of the content server 43 is not released, the data service node 23 generates the error message again and transmits it to the terminal 10 via the base station 21 (S94 and S95). In FIG. 8, the case where the data service node 23 performs the function of transmitting the error message when a reconnection attempt of the content server 43 registered as the connection disabled state occurs is exemplified. However, the function may be performed by the connection management server 44.

If the terminal user selects to receive the connection guide message in response to the error message (S90), the connection management server 44 periodically generates a state check message to check whether the content server 43 normally operates and transmits it to the content server 43 (S96).

If the content server 43 transitions to the normal operational state after the restoration, the content server 43 transmits a response to the state check message, and informs the connection management server 44 and the data service node 23 that the connection disabled state of the content server 43 is released (S97 and S98). The connection management server 44 recognizes that the connection disabled state of the content server 43 was released and requests the generation of the connection guide message from the message service center 22 (S99). The message service center 22 generates the connection guide message and transmits it to the terminal 10 via the base station 21 (S100 and S101). The connection guide message may be in the form of a WAP Push Message or a packet paging type.

Thereafter, a reconnection attempt occurs by sequentially performing a connection attempt (S102) by the terminal 10, a PPP connection request (S103) by the base station 21, and a socket connection request (S104) by the data service node 23. Since the content server 43 is in the normal operational state, the content server 43 performs the connection in response to the connection request (S105), and extracts page information according to the reconnection attempt and transmits it to the terminal 10 (S106 and S107).

The embodiment can be applied to an environment for providing mobile Internet services to a terminal. Accordingly, if the terminal attempts a connection to a particular site in Internet and fails to connect, a message is sent to guide the terminal to reconnect to the site after the server returns to the enabled state.

While the exemplary embodiments have been shown and described, it will be understood by those skilled in the art that various changes in form and details may be made thereto without departing from the spirit and scope of this disclosure as defined by the appended claims and their equivalents.

What is claimed is:

1. A server, comprising:
a communication unit to communicate with a terminal via a communication network;
a message generator to generate an error message if a connection attempt of the terminal occurs while the server is in a connection disabled state, and to generate a connection guide message if the connection disabled state is released;
a storage unit to store identification information of the terminal; and
a controller to control the storage unit to store the identification information of the terminal if the connection attempt of the terminal occurs while the server is in the connection disabled state, to control the message generator to generate the error message and transmit the error message to the terminal via the communication unit, and to control the message generator to generate the connection guide message with the terminal designated as a receiver and transmit the connection guide message to the terminal via the communication unit.

2. The server of claim 1, wherein the error message and the connection guide message are in the form of a WAP Push Message.

3. The server of claim 1, wherein the connection guide message is a packet paging type.

4. The server of claim 2, wherein the connection guide message comprises a page address used for connection to the server.

5. The server of claim 3, wherein the connection guide message includes a page address used for connection to the server.

6. A method for guiding server reconnection, comprising:
if a connection attempt of a terminal to a server occurs while the server is in a connection disabled state, storing identification information of the terminal, generating an error message, and transmitting the error message to the terminal; and
if the connection disabled state of the server is released, generating a connection guide message with the terminal designated as a receiver, and transmitting the connection guide message to the terminal.

7. The method of claim 6, wherein the error message and the connection guide message are in the form of a WAP Push Message.

8. The method of claim 6, wherein the connection guide message includes a page address used for connection to the server.

9. A method for server reconnection of a terminal, comprising:
attempting a first connection to a server, and receiving and displaying an error message informing that the server is in a connection disabled state;
receiving and displaying a connection guide message informing that the server's connection disabled state is released; and
attempting a second connection to an access address included in the connection guide message to connect to the server by the terminal.

10. The method of claim 9, wherein the error message and the connection guide message are in the form of a WAP Push Message.

11. The method of claim 9, wherein if the terminal attempts the first connection to the server and receives the error message, the terminal enters a dormant state.

12. The method of claim 11, wherein the connection guide message is a packet paging type.

13. A method for guiding reconnection to a server, comprising:
if a terminal attempts a first connection to a content server while the content server is in a connection disabled state, registering connection failure information comprising identification information of the content server and identification information of the terminal by a connection management server;
generating a first error message and transmitting it to the terminal; and
generating a connection guide message if the connection disabled state of the content server is released, and transmitting it to the terminal.

14. The method of claim 13, further comprising:
generating a second error message if the terminal attempts a second connection to the content server while the content server is in the connection disabled state, and transmitting the second error message to the terminal.

15. The method of claim 13, further comprising:
determining that the content server is in the connection disabled state if the content server does not respond to a first connection request within a predetermined time.

16. A method for guiding reconnection to a server, comprising:
if a terminal attempts a first connection to a content server while the content server is in a connection disabled state, registering connection failure information comprising identification information of the content server and the terminal by a connection management server;
generating a first error message, the first error message comprising an inquiry whether to receive a connection guide message after the connection disabled state of the content server is released, and transmitting the first error message to the terminal; and
generating a connection guide message if the connection disabled state of the content server is released after a response to the first error message is received from the terminal, and transmitting the connection guide message to the terminal.

17. The method of claim 16, wherein generating the connection guide message comprises:
receiving a response to the first error message from the terminal;
generating a state check message for checking whether the connection disabled state of the content server is released, and transmitting the state check message to the content server;
recognizing that the connection disabled state of the content server is released by receiving a response to the state check message from the content server; and
generating the connection guide message, and transmitting it to the terminal.

18. The method of claim 17, wherein generating the state check message further comprises:
periodically generating the state check message, and transmitting each state check message to the content server.

19. The method of claim 16, further comprising:
generating a second error message if the terminal attempts a second connection to the content server while the content server is in the connection disabled state, and transmitting the second error message to the terminal.
